(19) United States
(12) Patent Application Publication
(10) Pub. No.: US 2019/0279319 A1
(43) Pub. Date: Sep. 12, 2019

(54) System, method and software for the management of contract obligations

(71) Applicant: Verdantis Technologies Pvt. Ltd., Mumbai (IN)

(72) Inventors: Digesh Panchal, Mumbai (IN); Amit Shinde, Mumbai (IN)

(73) Assignee: Verdantis Technologies Pvt. Ltd., Mumbai (IN)

(21) Appl. No.: 16/269,255

(22) Filed: Feb. 6, 2019

(30) Foreign Application Priority Data
Mar. 6, 2018 (IN) 201821008137

(51) Int. Cl. G06Q 50/18; G06F 9/451

(52) U.S. Cl. CPC G06Q 50/18; G06F 9/451

(57) ABSTRACT

A software solution is described for the management of contract obligations. The software deems manual management of contract obligations redundant and hence provides for an error-free, simple and efficient technique to ensure that all parties adhere to the stipulations in the contract. The contract manager can easily monitor the compliance of all contracts from his/her dashboard.

### CROSS-REFERENCE TO RELATED APPLICATION

The instant application claims priority to Indian Patent Application Serial No. 201821008137, filed Mar. 6, 2018, pending, the entire specification of which is expressly incorporated herein by reference.

### FIELD OF INVENTION

The present invention relates to a system, method and software for the management of contract obligations.

### BACKGROUND OF THE INVENTION

Contract negotiation and management is a vital and necessary part of any business. Most contracts are complex and detailed documents, spanning hundreds of pages. Thus, it becomes difficult to keep a track of the points agreed to under the contract and whether all the concerned parties have adhered to their respective obligations as per the contract.

Performing contract management manually is a labor intensive task, and many a times is prone to error on part of the contract manager. Thus, there is a need for a simple and efficient solution for contract management—as proposed in the present disclosure. The present invention allows the contract manager to easily monitor the compliance of multiple contracts right from his/her dashboard.

The present invention performs the task of contract tracking and obligation management without the need for human intervention, thus completely minimizing the chance of error and/or overlooking of any terms or clauses mentioned in the contract. The use of this software significantly reduces the chances of any of the parties involved in a contract from defaulting from any terms or clauses negotiated in the contract.

US Patent Application Publication No. 2004/0083119 is directed to a system, method and Software product for vendor contract management. The Vendor Contract Management (VCM) System is a web application used to track obligations, payments and fees under each vendor contract.

US Patent Application Publication No. 2003/0115080 is a method of managing contracts using text mining, which includes storing a plurality of electronic contracts including unstructured textual data. The method further includes determining one or more linguistic patterns associated with a business parameter and generating linguistic rules based on the one or more linguistic patterns. The method further includes using text mining tools to extract information regarding the business parameter from the unstructured textual data using one or more of the linguistic rules.

US Patent Application Publication No. 2002/0111922 describes a method and system to enable, streamline, and enhance the cross-organizational processes of contract management.

While the above prior art disclosures provide a wide range of systems and methods related to software for tracking, analyzing and streamlining contracts, none of them employs a solution specifically for tracking of contract obligation management.

Accordingly, there exists a need for a method for the tracking of contract management obligations without the need for human intervention.

### OBJECTIVES OF THE INVENTION

A primary object of the present invention is to provide a system, method and software for the management of contract obligations.

### SUMMARY OF THE INVENTION

Before the present invention is described, it is to be understood that the present invention is not limited to particular methodologies and materials described, as these may vary as per the person skilled in the art. It is also to be understood that the terminology used in the description is for the purpose of describing the particular embodiments only, and is not intended to limit the scope of the present invention.

The present invention describes a method and software for the management of contract obligations.

The management process occurs through several steps as described in the following sentences—at each milestone (wherein a milestone is a specific periodic occasion), metrics (where in a metric is a contract parameter) are reviewed and marked for compliance or non-compliance. Once the review is performed, a notification is sent to the contract manager with the status of each contract metric.

In accordance with one embodiment of the present invention, a computer implemented system for the management of contract obligations is provided.

In accordance with one aspect of this embodiment, a subsystem for tracking and analysing contract compliance or non-compliance is provided.

In accordance with one aspect of this embodiment, a subsystem for organizing various types of obligations in a contract into various categories is provided.

In accordance with one aspect of this embodiment, a user defines milestones and assigns values in the form of metrics to the various obligations in a contract so as to create a matrix.

In accordance with one aspect of this embodiment, the user defines the metrics and associates milestones to the metrics so as to create the matrix.

In accordance with one aspect of this embodiment, the system tracks compliance by comparing values inputted by the user against the target values entered in the matrix.

In accordance with one aspect of this embodiment, the comparison occurs because the system is trained to extract relevant aspects from the obligation based on heuristic patterns.

In accordance with one aspect of this embodiment, the system reviews the contract for compliance when the milestone period is reached, wherein the milestone period is defined by the user and stored in the matrix.

In accordance with one aspect of this embodiment, a notification is sent to the user after each review.

In accordance with one aspect of this embodiment, the notification informs the user of the compliance or non-compliance of each obligation of the contract.

In accordance with one aspect of this embodiment, a notification is sent to the user when a milestone achieves fulfilment.

In accordance with one aspect of this embodiment, a dashboard can display to the user, a detailed view of each milestone and its associated metrics.

### BRIEF DESCRIPTION OF THE DRAWINGS

FIG. 1: Graphical representation of the trends in compliance status of the contract obligations.

FIG. 2: Defining and setting milestones for the reviewal of contract obligations.

FIG. 3: Dashboard showing compliance/non-compliance of an obligation by comparing value inputted by user against target metric value.

FIG. 4: A detailed view of each milestone and its associated metric is also available on the dashboard.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results.

The present invention describes a software solution for the management of contract obligations. The software deems manual management of contract obligations redundant and hence provides for an error-free, simple and efficient technique to ensure that all parties adhere to the stipulations in the contract. The contract manager can easily monitor the compliance of all contracts from his/her dashboard.

The contract manager must perform two simple tasks in order for the software to track contract obligations—first is to define milestones and the second is to create a matrix for obligations and assign metrics to it.

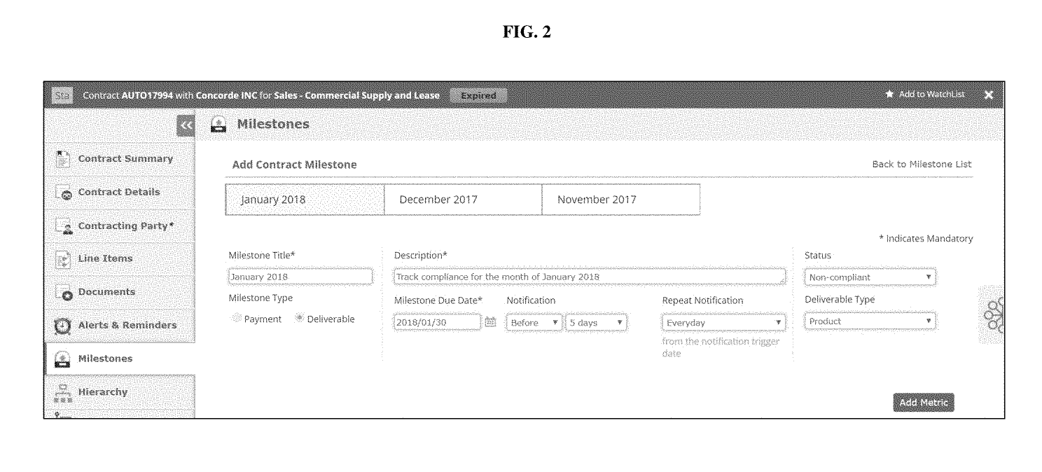

A milestone is a specific periodic occasion on which the contract parameters are reviewed for compliance. The contract manager can set the milestone as desired, as per the contract term. [FIG. 2].

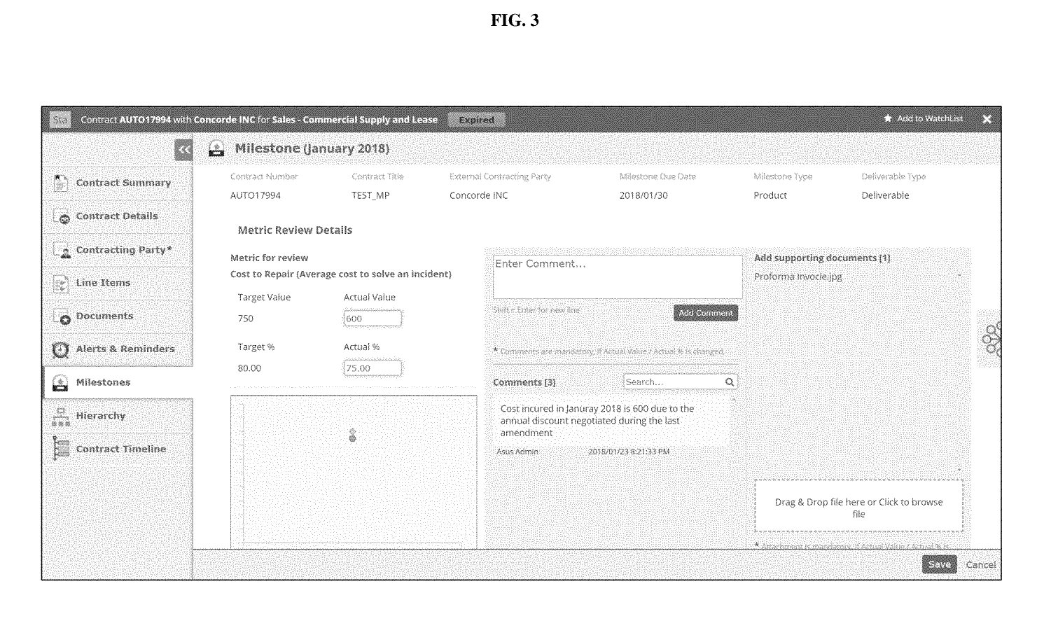

Each contract will have various obligations—these obligations can be classified into various categories, such as payment/deliverable based obligations, tax obligations, penalty free obligations, regulatory compliance obligations, etc. To check the compliance of each such obligation, the system is trained to extract relevant aspects from the clauses of these obligations, based on heuristic patterns. The contract manager can create a matrix for each obligation by entering information related to the contract clauses. For example, consider a delivery based obligation in which Party A has to deliver XYZ number of product units to Party B by a particular date. The contract manager will create a matrix for this particular obligation by providing the number of product units to be delivered, the current date and time, the date and time before which the complete delivery must be made and any updates as per the delivery in the intermittent period till the final date. The software continually takes in this data and updates the metrics. At any time, the contract manager can compare an input value against the target value set in the metric (XYZ in this particular example), and check for compliance or non-compliance. [FIG. 3] The delivery based obligation will be shown as compliant when the total of XYZ product units has been delivered to Party B by Party A. In a similar manner, the contract manager can create a matrix for all the obligations in the contract and then easily track the compliance of each obligation from his/her dashboard.

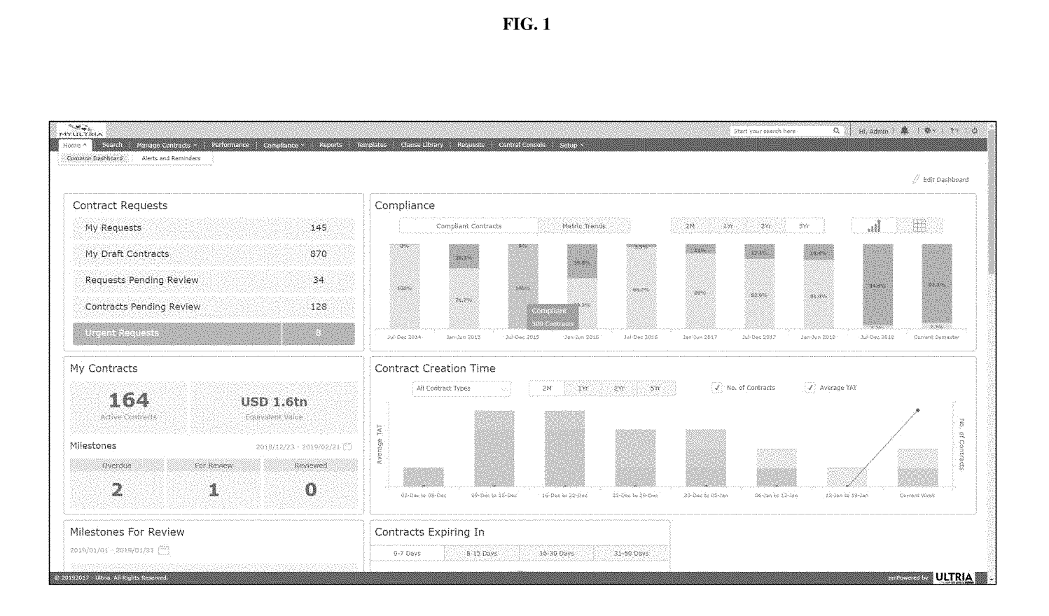

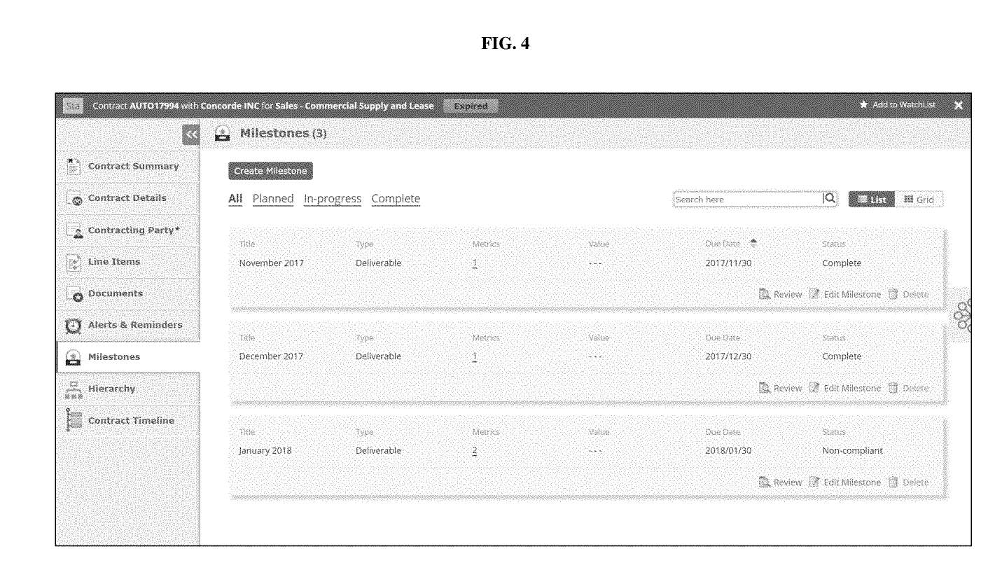

The software provides a graphical representation of the trends in compliance status and the metrics on which maximum contracts are non-compliant. [FIG. 1] After each review, a notification is sent to the contract manager with the status of the metrics (i.e., compliant or non-compliant). A detailed view of each milestone and it's associated metric is also available on the dashboard. [FIG. 4].

What is claimed is:

1. A computer implemented system for the management of contract obligations.

2. The contract obligation management system as claimed in claim 1, further comprising a subsystem for tracking and analysing contract compliance or non-compliance.

3. The contract obligation management system as claimed in claim 1, further comprising a subsystem for organizing various types of obligations in a contract into various categories.

4. The contract obligation management system as claimed in claim 1, wherein a user defines milestones and assigns values in the form of metrics to the various obligations in a contract so as to create a matrix.

5. The contract obligation management system as claimed in claim 4, wherein the user defines the metrics and associates milestones to the metrics so as to create the matrix.

6. The contract obligation management system as claimed in claim 5, wherein the system tracks compliance by comparing values inputted by the user against the target values entered in the matrix.

7. The comparison process as claimed in claim 6, wherein the comparison occurs because the system is trained to extract relevant aspects from the obligation based on heuristic patterns.

8. The contract obligation management system as claimed in claim 6, wherein the system reviews the contract for compliance when the milestone period is reached, wherein the milestone period is defined by the user and stored in the matrix.

9. The contract obligation management system as claimed in claim 8, wherein a notification is sent to the user after each review.

10. The notification as claimed in claim 9, wherein the notification informs the user of the compliance or non-compliance of each obligation of the contract.

11. The contract obligation management system as claimed in claim 4, wherein a notification is sent to the user when a milestone achieves fulfilment.

12. The contract obligation management system as claimed in claim 4, wherein a dashboard can display to the user, a detailed view of each milestone and its associated metrics.
